(19) United States
(12) Patent Application Publication
(10) Pub. No.: US 2019/0184214 A1
(43) Pub. Date: Jun. 20, 2019

(54) EMERGENCY EGRESS SYSTEM AND ANCHOR ASSEMBLY THEREFOR

(71) Applicant: SkySaver Rescue Ltd., Jerusalem (IL)

(72) Inventors: Avner Farkash, Yakir (IL); Barak Farkash, Rechelim (IL)

(21) Appl. No.: 16/330,997

(22) PCT Filed: Sep. 7, 2017
(86) PCT No.: PCT/IL2017/051005

§ 371 Date: Mar. 6, 2019

(30) Foreign Application Priority Data
Sep. 8, 2016 (IL) 247725

(51) Int. Cl. A62B 35/00

(52) U.S. Cl. CPC A62B 35/0068

(57) ABSTRACT

An anchor assembly configured for receiving therein and gripping a wall is provided. The anchor assembly comprises first and second anchor arms pivotable between a collapsed, storage position and an open, operable position in which the anchor arms define therebetween a clamping area for receiving the wall. Each of the anchor arms has a bent shape which is open in the operable position toward the clamping area. Distal ends of the anchor arms comprise first and second contact arrangements configured for bearing on the wall during use. The first anchor arm comprises a coupling arrangement facilitating coupling thereto an external cable assembly. The anchor assembly is configured such that, when the wall is received within the clamping area and the contact arrangements bear against an opposite face of the wall, a force is applied to the anchor assembly away from the clamping area biasing the contact arrangements toward the wall.

### TECHNOLOGICAL FIELD

The presently disclosed subject matter is directed toward systems for emergency egress from a structure. More particularly, it is directed toward anchors for such systems.

### BACKGROUND

Occupancy of tall buildings is common for both residential and commercial purposes. Such buildings are typically constructed with provisions (fire escapes, emergency stairwells, etc.) for quick egress for use in emergencies. However, these provisions may not be suitable in every emergency, for example if they do not provide sufficient capacity for all occupants to exit the building in sufficient time, or if they become obstructed.

Controlled descent devices partially address this issue, as they provide additional capacity for evacuating people from a building. In addition, they may be portable, allowing safe egress from a building from one of several egress points in the building (e.g., windows), which allows their use even if some of the egress points become obstructed.

### SUMMARY

According to one aspect of the presently disclosed subject matter, there is provided an anchor assembly configured for receiving therein and gripping a wall, the anchor assembly comprising first and second anchor arms pivotable about at least one pivot axis by a pivoting arrangement between a collapsed, storage position and an open, operable position in which the anchor arms define therebetween a clamping area for receiving the wall therein;

each of the first and second anchor arms has a bent shape which is open, when the anchor assembly is in its operable position, toward the clamping area;

proximal ends of the anchor arms are pivotally connected to the pivoting arrangement to form therebetween, in the operable position, a pivot angle not exceeding a maximum pivot angle and facing the clamping area;

distal ends of each of the anchor arms comprise, respectively, first and second contact arrangements configured for bearing on the wall during use;

the first anchor arm comprises a coupling arrangement to facilitate coupling thereto an external cable assembly;

wherein the anchor assembly is configured such that, when in its operable position with the wall received within the clamping area and each of the contact arrangements bearing against an opposite face of the wall, a force applied to the anchor assembly and directed away from the clamping area biases each of the contact arrangements toward the wall.

Each of the first and second anchor arms may comprise, respectively, a first or second substantially linear support member rigidly connected at a proximal end thereof to a distal end of, respectively, a first or second articulation member thereof and forming, respectively, a first or second angle, facing the clamping area, therewith.

The second anchor arm may further comprise an auxiliary member rigidly connected between the second articulation and support members. The first angle may be larger than the second angle. The second articulation arm may be longer than the first articulation arm.

Each of the anchor arms may be formed as a unitary element.

The pivoting arrangement may facilitate pivoting of the first and second anchor arms directly to each other.

Each of the articulation members may comprise, at its proximal end, respective first or second extensions being curved toward the other of the articulation members and overlapping the other extension, the pivoting arrangement comprising an axle passing though the extensions.

Each of the extensions may comprise a restricting element projecting toward the other extension and configured for obstructing it during pivoting, thereby restricting the pivot angle to the maximum pivot angle.

The maximum pivot angle may be approximately 120°. The maximum pivot angle may be approximately 90°.

The height of the anchor arms in a direction parallel to the pivot axis may be at least twice the width thereof in a direction perpendicular to the pivot axis.

Each of the contact arrangements may comprise a carrying element articulated to the distal end of its respective anchor arm to pivot about an axis parallel to the pivot axis, and a pad for the bearing on the wall, and configured to facilitate contact therewith. The pad may be made of an elastomeric material.

The coupling arrangement may comprise a substantially U-shaped element pivotally articulated to the first anchor arm.

According to another aspect of the presently disclosed subject matter, there is provided a system for facilitating egress from a structure, the system comprising an anchor assembly as described above for receiving therein and gripping a wall of the structure, and a cable assembly for being suspended from the anchor assembly.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic illustration of a system according to the presently disclosed subject matter, for facilitating emergency egress from a structure;

FIG. 2 is a perspective view of an anchor assembly of the system illustrated in FIG. and

FIG. 3 is a side view of the anchor assembly illustrated in FIG. 2 in use.

### DETAILED DESCRIPTION

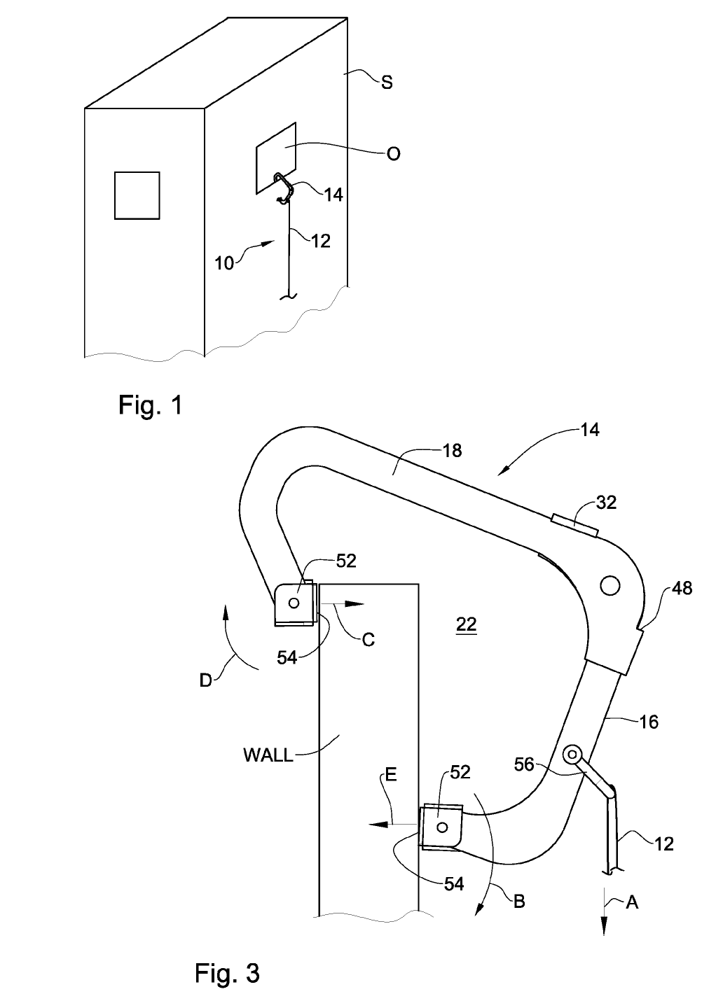

As illustrated in FIG. 1, there is provided a system, which is generally indicated at 10, for facilitating emergency egress from a structure S via, e.g., an opening O such as a window providing access from the interior to the exterior of a building, typically from a great height, such as one from which it is unsafe to descend without external assistance. The structure comprises a cable assembly 12 and an anchor assembly 14. The cable assembly 12 is coupled to the anchor assembly 14 for suspension therefrom and is configured for bearing a load (typically one or more people), and facilitating its suspension in midair and/or lowering it to the ground. The cable assembly may comprise any suitable arrangement, including, but not limited to a harness and/or brake, for example as described in one or more of co-pending U.S. patent application Ser. No. 14/624,856, Israel application no. 235049, and international applications no. PCT/IL2016/050191 and PCT/IL2015/050998, all to the present applicant, the full contents of which are incorporated herein by reference, mutatis mutandis.

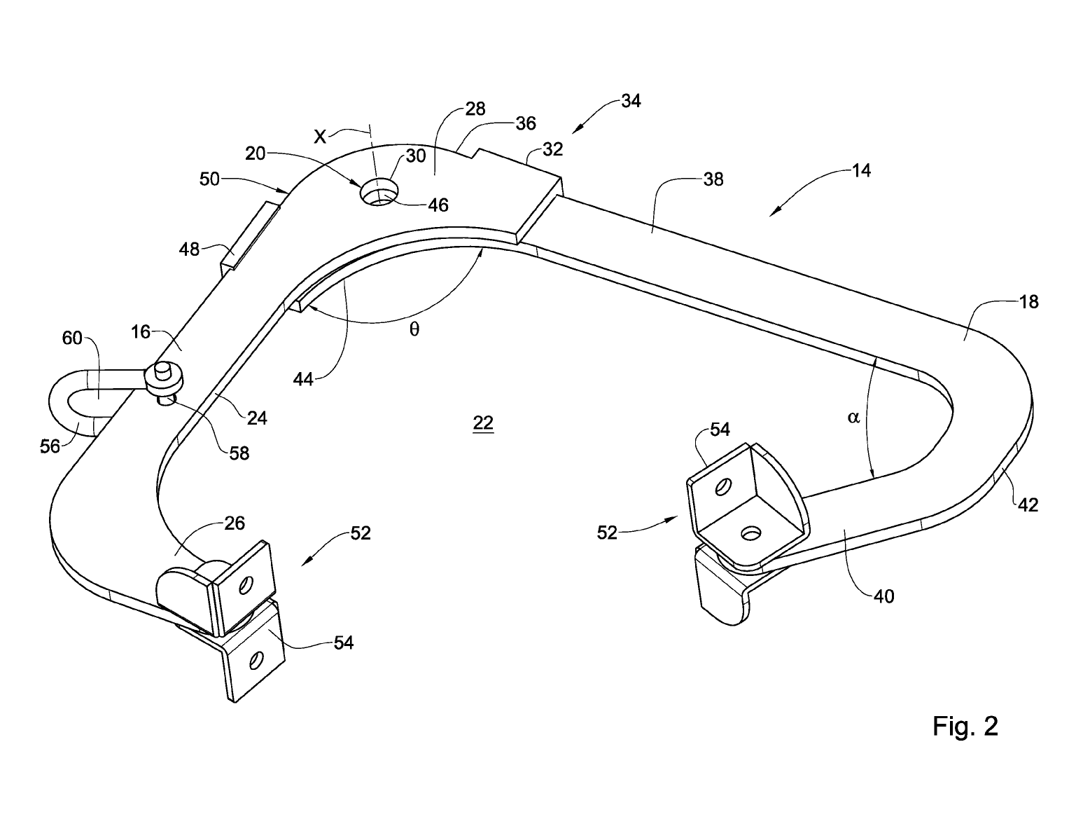

The anchor assembly 14 is configured for being connected to and bearing the cable assembly 12, and for gripping a wall or other suitable portion of the structure, thereby constituting a base of the system 10. As illustrated in FIG. 2, the anchor assembly 14 may have a generally C-shaped form, and comprises first and second anchor arms 16, 18 pivotally articulated to each other at proximal ends thereof, about a pivot axis X. A suitable pivoting arrangement (not illustrated for clarity), such as a hinge, pin, etc., is provided (e.g., at a location indicated by 20) to facilitate the articulation of the anchor arms 16, 18.

The anchor arms 16, 18 define, when in an operable position of the anchor assembly 14 as illustrated in FIG. 2, a clamping area 22 therebetween. A pivot angle θ, open toward the clamping area 22, is defined between the anchor arms 16, 18. The maximum pivot angle θ may be limited to a maximum value, as described below. During use, the wall of the structure is received within the clamping area 22 for being gripped by the anchor assembly 14. In addition, anchor arms 16, 18 may be pivoted fully toward one another in a storage position, for example to reduce the amount of space occupied by the anchor assembly 14 when not in use.

The anchor arms 16, 18 are each formed having a bent shape, open toward the clamping area 22 (in the operative position of the anchor assembly 14). The first anchor arm 16 comprises a first articulation member 24 rigidly coupled at a distal end thereof to an optionally shorter first support member 26 at a proximal end thereof, and forming an angle therewith, for example about 90° (open toward the clamping area). It further comprises an extension 28 at its proximal end, comprising a through-going aperture 30 for receiving therethrough the pivoting arrangement, and being curved toward the second anchor arm 18. A first restricting element 32, constituting a portion of a limiting arrangement 34, projects therefrom toward the second anchor arm 18, for example disposed at a proximal-most edge 36 thereof.

The second anchor arm 18 comprises a second articulation member 38 rigidly coupled at a distal end thereof to an optionally shorter second support member 40 at a proximal end thereof, and forming an angle α therewith, for example substantially less than 90° (open toward the clamping area), for example about 45°. The angle α may be larger for smaller maximum pivot angles θ, and larger for smaller maximum pivot angles θ. For example, the anchor assembly 14 may be provided such that the sum of the angle α and the maximum pivot angle θ does not exceed about 150°. According to some examples, the second articulation member 38 is longer than the first articulation member 24.

An auxiliary member 42, rigidly connected to and spanning between the second articulation and support members 38, 40, may be provided. The auxiliary member 42 contributes toward a reduced overall size of the anchor assembly 14, and in particular of the second anchor arm 18, in view of the acute angle formed between the second articulation and support members 38, 40 (i.e., without the auxiliary member, the second articulation and support members would require longer lengths in order to form an angle significantly less than 90°, as described above). Accordingly, it will be appreciated that while the auxiliary member 42 is illustrated in FIG. 2 as a substantially linear element, it may be constituted by a curved portion spanning between the second articulation and support members 38, 40, mutatis mutandis.

The second anchor arm 18 further comprises an extension 44 at its proximal end, comprising a through-going aperture 46 for receiving therethrough the pivoting arrangement, and being curved toward the first anchor arm 16 and overlapping the extension 28 thereof. A second restricting element 48, constituting a second portion of the limiting arrangement 34, projects therefrom toward the first anchor arm 16, for example disposed at a proximal-most edge 50 thereof.

It will be appreciated that while each of the anchor arms 16, 18 is described herein as comprising several members, each may be formed as a unitary element, i.e., made of a single piece of material. Alternatively, one or both may be made of several members rigidly connected to one another.

The anchor arms 16, 18 may be provided such that they are substantially flat. Accordingly, the anchor assembly 14 may be more compact in its storage position. In particular, the height of each of the anchor arms 16, 18, when considered in a direction which is parallel to the pivot axis X, is much larger than their widths, i.e., considered in a direction which is perpendicular to the pivot axis. The height may be at least twice the width, for example being at least three, at least four, at least five, or at least six times the width.

The limiting arrangement 34 functions to limit the pivot angle θ (which is measured between the articulation members 24, 38 of the anchor arms 16, 18) to a maximum value, e.g., about 90°. The first restricting element 32 is disposed such that when the maximum pivot angle θ is reached between the anchor arms 16, 18, the second anchor arm 18 bears against it, and is thus obstructed thereby. Similarly, the second restricting element 48 is disposed such that when the maximum pivot angle θ is reached between the anchor arms 16, 18, the first anchor arm 16 bears against it, and is thus obstructed thereby. It will be appreciated that while the limiting arrangement 34 may comprise only one of the restricting elements 32, 48, the anchor assembly 14 may be provided with both to increase stability of the anchor assembly 14 in its operative position.

It will be appreciated that the limiting arrangement 42 may be configured so as to determine only the maximum pivot angle θ, without any arrangements which may be used to govern pivot angles θ below the maximum. For example, as illustrated in FIG. 2, the maximum pivot angle θ is governed by the limiting arrangement 44, and no other arrangement is present to arrest or limit the anchor arms 16, 18 at any other position. Accordingly, the anchor assembly 14 may be easily and quickly opened to its operable position, for example in the event of an emergency.

The anchor assembly 14 further comprises arrangements for increasing the contact area between the distal ends of the anchor arms 16, 18 and the wall of the structure when in use, thereby increasing the stability of the anchor assembly as a base of the system 10. Accordingly, contact arrangements 52 are provided at the distal ends of the anchor arms 16, 18. Each of the contact arrangements 52 comprises a contact surface 54 for bearing on the wall during use, and a hinge element (not illustrated), such as a pin, configured to facilitate pivoting of the contact arrangement about an axis parallel to the pivot axis X. In addition, a pad (not illustrated) may be provided on the contact surface 54, for example 30 to protect the wall from damage caused by impact of the contact arrangement 52 therewith, to increase friction thereby facilitating a stronger “grip” of the anchor arrangement with the wall, etc. The pad may be made of an elastomeric or any other suitable material.

The anchor assembly 14 may further comprise a coupling arrangement 56 for facilitating coupling the cable assembly 12 thereto. It may have any suitable construction suitable for this purpose, and may be customized for the specific features of the cable assembly 12. For example, it may define an opening for passing a corresponding element of the cable assembly 12 therethrough. According to one non-limiting design, the coupling arrangement 56 comprises a U-shaped element pivotally articulated at its open end to the first anchor arm 16, for example through an aperture 58 formed therein, thereby defining an opening 60 therewithin. It will be appreciated that the coupling arrangement may be rigidly connected to the first anchor arm 16, and may be integrated therewith (for example being constituted by an aperture formed in the first anchor arm)

In use, as illustrated in FIG. 3, the anchor 14 is placed over a wall (for example directly below a window) or other similar part of a structure, such that the wall is received within the clamping area 22, and the contacting arrangement 52 connected to the second anchor arm 18 bears against the inside surface of the wall, and the connecting arrangement 52 connected to the first anchor arm 16 bears against the outside surface of the wall. The cable assembly 12 is free to hang down. The weight of the load borne by the cable assembly 12 exerts a downward force away from the clamping area, indicated by arrow A, on the coupling arrangement 56.

This force creates a moment (indicated by arrow B) about the coupling arrangement 52 connected to the first anchor arm 16, which causes the other coupling arrangement 52 to bear on the inside of the wall with a force indicated at arrow C. Similarly, the downward force exerted by the weight of the person creates a moment (indicated by arrow D) about the coupling arrangement 52 connected to the second anchor arm 18, which causes the other coupling arrangement 52 to bear on the outside of the wall with a force indicated at arrow E. The forces which bear on the wall facilitate a tight gripping of the wall by the anchor assembly 14.

It will be appreciated that the greater the weight of the person borne by the cable assembly 12, i.e., the greater the force indicated at arrow A, the greater the forces (indicated by arrows C and E) which the anchor assembly bear on the wall, and the tighter the grip. Thus, the anchor assembly is configured to grip the wall with a greater force correspondingly with a necessity of a greater gripping force owing to an increased load.

Those skilled in the art to which this invention pertains will readily appreciate that numerous changes, variations, and modifications can be made without departing from the scope of the presently disclosed subject matter, mutatis mutandis.

1. A system for facilitating egress from a structure, the system comprising:
an anchor assembly for receiving therein and gripping a wall of the structure, and a cable assembly for being suspended from the anchor assembly,
the anchor assembly comprising first and second anchor arms pivotable about at least one pivot axis by a pivoting arrangement between a collapsed, storage position and an open, operable position in which said anchor arms define therebetween a clamping area for receiving said wall therein;
each of said first and second anchor arm having a bent shape which is open, when the anchor assembly is in its operable position, toward said clamping area;
proximal ends of said anchor arms being pivotally connected to said pivoting arrangement to form therebetween, in the operable position, a pivot angle not exceeding a maximum pivot angle and facing said clamping area;
distal ends of each of said anchor arms comprising, respectively, first and second contact arrangements configured for bearing on said wall during use;
said first anchor arm comprising a coupling arrangement to facilitate coupling thereto said cable assembly;
wherein said anchor assembly is configured such that, when in its operable position with the wall received within said clamping area and each of said contact arrangements bearing against an opposite face of the wall, a force applied to said anchor assembly and directed away from said clamping area biases each of said contact arrangements toward the wall.

2. The system according to claim 1, wherein each of said first and second anchor arms comprises, respectively, a first or second substantially linear support member rigidly connected at a proximal end thereof to a distal end of, respectively, a first or second articulation member thereof and forming, respectively, a first or second angle, facing said clamping area, therewith.

3. The system according to claim 2, wherein said second anchor arm further comprises an auxiliary member rigidly connected between said second articulation member and said second support member.

4. The system according to claim 2, wherein the first angle is larger than said second angle.

5. The system according to claim 2, wherein the second articulation arm is longer than the first articulation arm.

6. The system according to claim 1, wherein each of said anchor arms is formed as a unitary element.

7. (canceled)

8. The system according to claim 1, wherein said pivoting arrangement facilitates pivoting of said first and second anchor arms directly to each other, each of said articulation members comprising, at its proximal end, respective first or second extensions being curved toward the other of the articulation members and overlapping the other extension, said pivoting arrangement comprising an axle passing though said extensions.

9. The system according to claim 8, wherein each of said extensions comprises a restricting element projecting toward the other extension and configured for obstructing it during pivoting, thereby restricting said pivot angle to the maximum pivot angle.

10. The system according to claim 1, wherein said maximum pivot angle is approximately 120°.

11. (canceled)

12. (canceled)

13. The system according to claim 1, wherein each of the contact arrangements comprises a carrying element articulated to the distal end of its respective anchor arm to pivot about an axis parallel to said pivot axis, and a pad for the bearing on the wall, and configured to facilitate contact therewith.

14. (canceled)

15. (canceled)

16. An anchor assembly configured for receiving therein and gripping a wall, said anchor assembly comprising first and second anchor arms pivotable about at least one pivot axis by a pivoting arrangement between a collapsed, storage position and an open, operable position in which said anchor arms define therebetween a clamping area for receiving said wall therein;
each of said first and second anchor arms having a bent shape which is open, when the anchor assembly is in its operable position, toward said clamping area;
proximal ends of said anchor arms being pivotally connected to said pivoting arrangement to form therebetween, in the operable position, a pivot angle not exceeding a maximum pivot angle and facing said clamping area;
distal ends of each of said anchor arms comprising, respectively, first and second contact arrangements configured for bearing on said wall during use;
said first anchor arm comprising a coupling arrangement to facilitate coupling thereto an external cable assembly;
wherein said anchor assembly is configured such that, when in its operable position with the wall received within said clamping area and each of said contact arrangements bearing against an opposite face of the wall, a force applied to said anchor assembly and directed away from said clamping area biases each of said contact arrangements toward the wall.

17. The anchor assembly according to claim 16, wherein each of said first and second anchor arms comprises, respectively, a first or second substantially linear support member rigidly connected at a proximal end thereof to a distal end of, respectively, a first or second articulation member thereof and forming, respectively, a first or second angle, facing said clamping area, therewith.

18. The anchor assembly according to claim 17, wherein said second anchor arm further comprises an auxiliary member rigidly connected between said second articulation member and said second support member.

19. The anchor assembly according to claim 17, wherein the first angle is larger than said second angle.

20. The anchor assembly according to claim 17, wherein the second articulation arm is longer than the first articulation arm.

21. The anchor assembly according to claim 16, wherein each of said anchor arms is formed as a unitary element.

22. (canceled)

23. The anchor assembly according to claim 16, wherein said pivoting arrangement facilitates pivoting of said first and second anchor arms directly to each other, each of said articulation members comprising, at its proximal end, respective first or second extensions being curved toward the other of the articulation members and overlapping the other extension, said pivoting arrangement comprising an axle passing though said extensions.

24. The anchor assembly according to claim 23, wherein each of said extensions comprises a restricting element projecting toward the other extension and configured for obstructing it during pivoting, thereby restricting said pivot angle to the maximum pivot angle.

25. (canceled)

26. The anchor assembly according to claim 16, wherein said maximum pivot angle is approximately 90°.

27. (canceled)

28. The anchor assembly according to claim 16, wherein each of the contact arrangements comprises a carrying element articulated to the distal end of its respective anchor arm to pivot about an axis parallel to said pivot axis, and a pad for the bearing on the wall, and configured to facilitate contact therewith.

29. (canceled)

30. (canceled)
